(19) United States
(12) Patent Application Publication
(10) Pub. No.: US 2025/0378098 A1
(43) Pub. Date: Dec. 11, 2025

(54) LLM-POWERED DATA FILTERING

(71) Applicant: SAP SE, Walldorf (DE)

(72) Inventors: Jakub Djablik, Brno (CZ); Marek Halas, Brno (CZ); Tomas Rysavy, Brno (CZ); Richard Kuba, Brno (CZ); Ivan Pudelka, Brno (CZ)

(21) Appl. No.: 18/737,064

(22) Filed: Jun. 7, 2024

(51) Int. Cl. G06F 16/335; G06F 16/31

(52) U.S. Cl. CPC G06F 16/335; G06F 16/245; G06F 16/328

(57) ABSTRACT

A user provides natural-language filtering instructions to an application server. The natural-language filtering instructions are provided to a large language model (LLM) and the LLM generates filtering commands. The filtering commands may be in a format expected by a database or in a format suitable for post-processing to generate database commands. Manual filter options may also be received from the user and used to generate additional filtering commands for the database. Responsive data is provided by a user interface. The LLM may be configured for the database or database tables being filtered. For example, metadata for the database or database tables may be used to programmatically generate a data format to be used to provide filtering commands. The LLM is instructed to generate output using the data format.

### TECHNICAL FIELD

The subject matter disclosed herein generally relates to systems for filtering data and, more specifically, to systems utilizing large language models (LLMs) to control filtering of data in database tables.

### BACKGROUND

Database tables can be complex, including thousands of records and dozens of columns. Accessing relevant data for a particular purpose requires manually configuring filters to select the columns and records to access.

### BRIEF DESCRIPTION OF THE DRAWINGS

FIG. 1 shows a network diagram illustrating an example network environment suitable for LLM-powered data filtering.

FIG. 2 shows a block diagram of an application server, suitable for LLM-powered data filtering.

FIG. 3 is a block diagram of a neural network, suitable for use as an LLM that generates database filtering commands, according to some example embodiments.

FIG. 4 shows an illustration of an example database schema, suitable for being filtered by LLM-generated commands.

FIG. 5 shows an illustration of an example user interface for manual data filtering.

FIG. 6 shows an illustration of an example user interface for LLM-powered data filtering.

FIG. 7 shows an illustration of an example user interface for displaying results from LLM-powered data filtering.

FIG. 8 shows a flowchart illustrating a method of LLM-powered data filtering.

FIG. 9 shows a block diagram showing one example of a software architecture for a computing device.

FIG. 10 shows a block diagram of a machine in the example form of a computer system within which instructions may be executed for causing the machine to perform any one or more of the methodologies discussed herein.

### DETAILED DESCRIPTION

Example methods and systems are directed to LLM-powered data filtering. As described herein, a machine learning model is used to receive natural-language data requests and generate database commands. For example, the database commands may be generated using JavaScript object notation (JSON), structured query language (SQL), or any suitable combination thereof.

In existing database systems, filters can be very complicated. For example, a table may include thousands of records and dozens of columns. Configuring filters may require knowledge of the data in the table and technical skills relating to particular types of filters or databases. Using the systems and methods disclosed herein, a user provides natural-language filtering instructions to an application server (e.g., by typing into a text box, providing a voice input, or any suitable combination thereof). The natural-language filtering instructions are provided to an LLM, and the LLM generates filtering commands in a format expected by the database.

Text received from the user may be provided to the LLM as each word is received. Attention data from the LLM may be used to highlight the words that have substantial impact on the output generated by the LLM, allowing the user to see which parts of the text are understood by the LLM. Manual filters options may also be received from the user and used to generate additional filtering commands for the database. The filtering commands generated by the LLM may be presented in the user interface, allowing the user to manually modify them before submitting them to the database.

Using the LLM interface allows the user to request data without knowing the specific structure of the database. For example, a request for “invoices at least a year old” may be translated by the LLM to a request for records in the Invoice table with a CreationDate at least one year before the current date, even though the user did not specify the CreationDate column name. Likewise, a request for a field that uses a synonym instead of the correct name can be corrected by the LLM. The LLM may also recognize that requests based on certain types of data can only be met by filters on a particular column. For example, if only one column contains names and the natural-language request mentions “John,” the LLM may generate filtering commands for the value of the column to be equal to “John,” even though the user did not specify the column to be filtered.

The LLM may be configured for the database or database tables being filtered. For example, metadata for the database or database tables may be used to programmatically generate instructions for the LLM.

A wrapper service may be used to interact with the LLM. For example, a first party may control the database, a second party may provide the natural-language filtering instructions, and a third party may control the LLM. The wrapper service may provide the natural-language filtering instructions and the instructions for generating database commands to the LLM without providing the contents of the database tables filtered. As a result, the third party does not receive the (potentially confidential) information from the database.

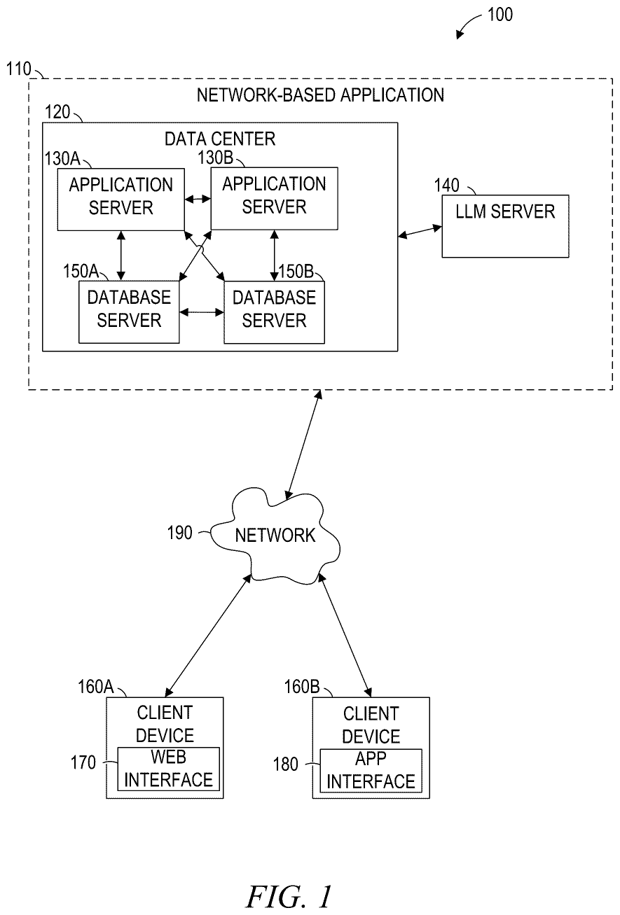

FIG. 1 shows a network diagram illustrating an example network environment 100 suitable for LLM-powered data filtering. The network environment 100 includes a network-based application 110, an LLM server 140, client devices 160A and 160B, and a network 190. The network-based application 110 is implemented at a data center 120 comprising application servers 130A and 130B in communication with database servers 150A and 150B. An application executing on the application servers 130A-130B may access data from the database servers 150A-150B. The letter suffixes of reference numbers may be omitted when doing so does not raise ambiguity. For example, the application servers 130A-130B may be referred to collectively as “application servers 130.” Similarly, when the specific one of the application servers 130A-130B is not of particular import, “application server 130” may be referenced.

The application running on the application server 130 may provide services to the client devices 160A and 160B. For example, a user of the client device 160A may be an employee of a business using a business application. The user may use the services to generate invoices, manage employees, develop other applications, or any suitable combination thereof. Use of the application may entail filtering data (e.g., to review certain invoices, employees, applications, or the like). The user interface for the application may be presented using a web interface 170 or an app interface 180.

The LLM server 140 may include a machine learning model trained to convert natural-language instructions into database commands. A user of a client device 160 may send natural-language filtering instructions to an application server 130. The application server 130 sends the natural-language filtering instructions to the LLM server 140 and receives, in response, database commands. The application server 130 provides the database commands to a database server 150 and receives, in response, filtered data. The application server 130 may provide the filtered data to the client device 160 for presentation to the user.

The application servers 130 may communicate with the database servers 150 using a representational state transfer (REST) API, the Open Data Protocol (ODATA), or another API. The data may be described in metadata that provides contextual information related to the data. Metadata includes column names, data types and data relationships. If the values are from a fixed dataset, the dataset may be loaded and the loaded information used as a table description.

The LLM server 140 and the application servers 130 may communicate using system messages and user messages. The system messages help to set the behavior of the LLM. The user messages provide requests or comments for the LLM to respond to. The system message may be formed from a static part, a dynamic part, or both. The static part may define the LLM's behavior such as, for example, by defining how the LLM should handle the requests and how the LLM should respond to the requests. The static part may also define the exact response format in which the LLM is to provide the filters to be set. The response format is designed to be easily parsed in application code (e.g., using a JSON schema as a template). Alternatively, LLM functions may be used, wherein the LLM responds with a function call. The parameters of the function call may be parsed as filter parameters.

The dynamic part of the system message is generated based on placeholders for the filter context. The placeholders are replaced with some or all of the contextual data extracted from the metadata received from the database server 150 such as, for example, column names, data types, enumerations for fixed values, the current date and time, or any suitable combination thereof.

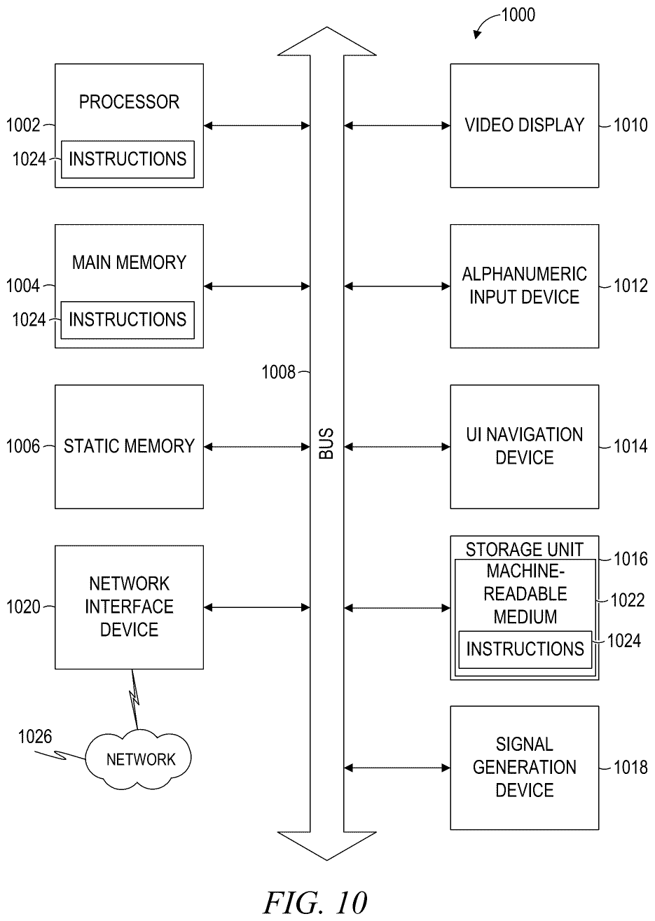

The application servers 130A-130B, the LLM server 140, the database servers 150A-150B, and the client devices 160A-160B may each be implemented in a computer system, in whole or in part, as described below with respect to FIG. 10. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the LLM server 140, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one LLM server 140, two application servers 130A-130B, two client devices 160A and 160B, and the like), any number of each element is contemplated. For example, the application server 130A may be one of dozens or hundreds of active and standby servers and provide services to millions of client devices. Likewise, the LLM server 140 may be used by many application servers 130, and so on.

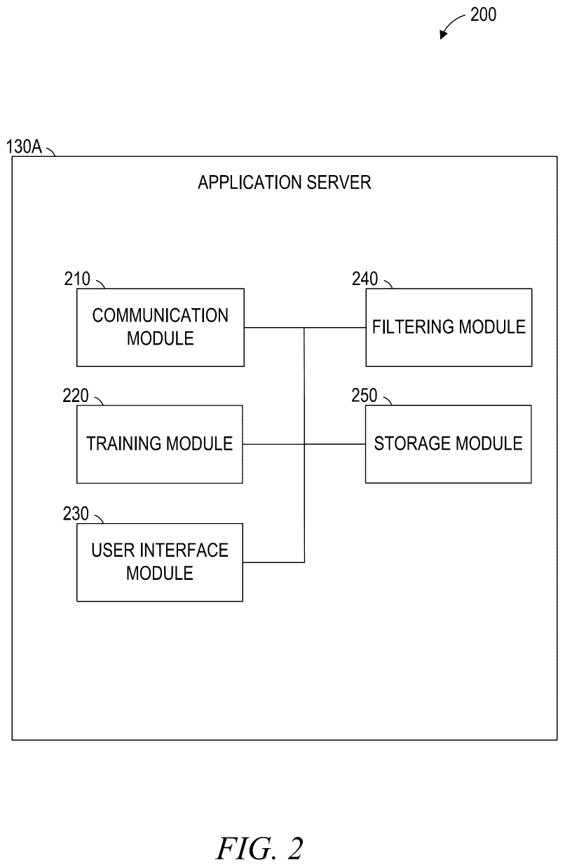

FIG. 2 shows a block diagram 200 of the application server 130A, suitable for LLM-powered data filtering. The application server 130A is shown as including a communication module 210, a training module 220, a user interface module 230, a filtering module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. For example, the communication module 210 may send a user interface (e.g., hypertext markup language [HTML] for rendering in a web browser) from the user interface module 230 to the client device 160A. The communication module 210 may receive, from the client device 160A and via the user interface, a natural-language request for data from the database server 150A. In response, the communication module 210 provides the natural-language request to the LLM server 140 and, in response, receives database commands. The communication module 210 may send the database commands to the database server 150A and receive, in response, data corresponding to the natural-language data request. The user interface module 230 causes the user interface to be updated with the responsive data.

The training module 220 trains an LLM of the LLM server 140. The training includes providing a training set of historical natural-language requests and corresponding database commands to the LLM. For example, the training module 220 may provide a training set comprising natural-language filtering instructions and JSON objects comprising corresponding filtering commands. As another example, the training module 220 may provide a training set comprising natural-language filtering instructions and structured query language (SQL) strings comprising corresponding filtering commands. In some example embodiments, the training module 220 is not used. Instead, a general-purpose LLM provided by the LLM server 140 is used without additional domain-specific training.

The filtering module 240 may combine the database commands received from the LLM server 140 with additional database commands received via the user interface provided by the user interface module 230. For example, a user might provide a natural-language request for data relating to certain clients or products and use a date-picker to select a date range of interest. The LLM server 140 generates database commands (e.g., a JSON object, SQL string, or any suitable combination thereof) for the natural-language request. The filtering module 240 modifies the database commands to include a date filter that corresponds to values selected by the user using the date-picker. The modified database commands are provided to a database server 150 for processing.

Data, metadata, documents, instructions, or any suitable combination thereof may be stored and accessed by the storage module 250. For example, local storage of the application server 130A, such as a hard drive, may be used. As another example, network storage may be accessed by the storage module 250 via the network 190.

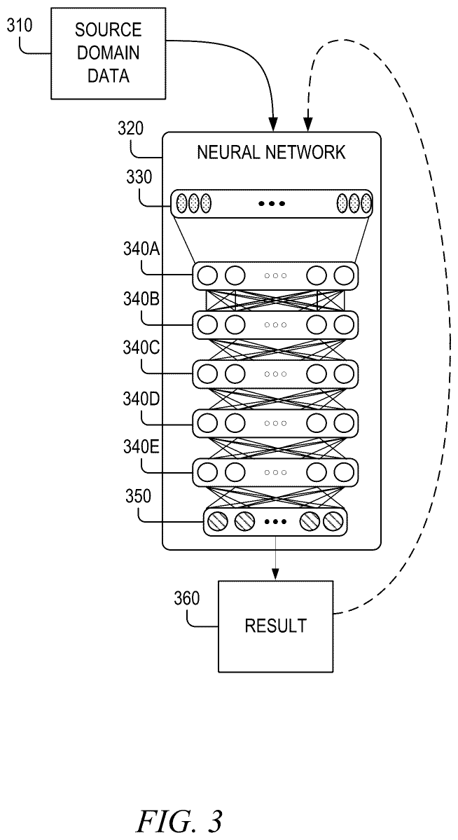

FIG. 3 is a block diagram of a neural network 320, suitable for use as an LLM that generates database filtering commands, according to some example embodiments. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset while the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like. With the help of natural language processing (NLP) and advanced data pre-processing, a machine learning model (e.g., the neural network 320) can be trained on existing data (for instance, natural-language filtering instructions) from the system to generate corresponding output (e.g., database commands).

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

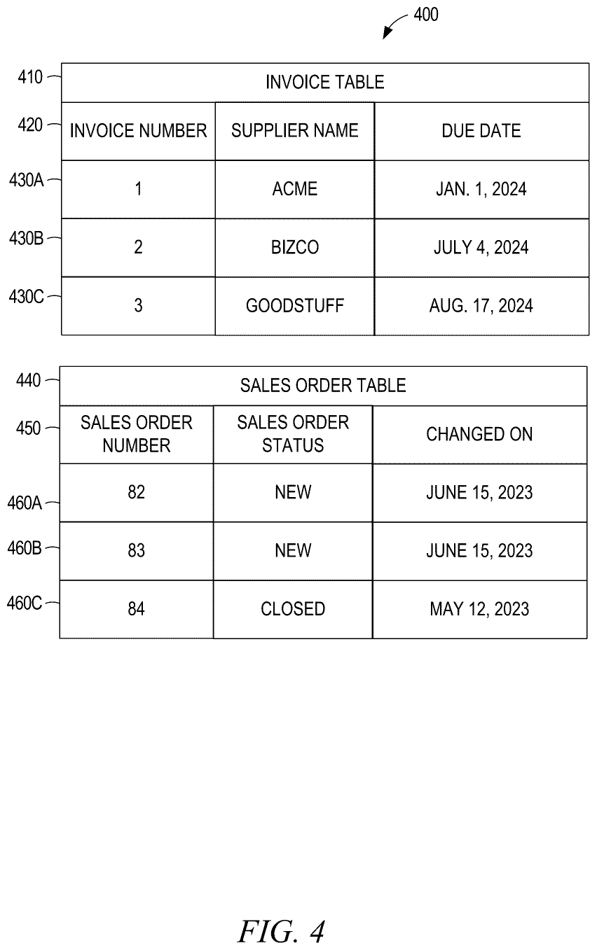

FIG. 4 shows an illustration of an example database schema 400, suitable for being filtered by LLM-generated commands. The database schema 400 includes an invoice table 410 and a sales order table 440. The invoice table 410 includes rows 430A, 430B, and 430C of a format 420. The sales order table 440 includes rows 460A, 460B, and 460C of a format 450.

Each of the rows 430A-430C of the invoice table 410 includes an invoice number, a supplier name, and a due date, as indicated by the format 420. The sales order table 440 shows a sales order number, a sales order status, and a changed-on date, as indicated by the format 450.

The invoice table 410, the sales order table 440, or both, may include more or fewer fields than shown in FIG. 4. Example additional fields include: a type of invoice, a paid-on date, a created date, contact information, or any suitable combination thereof. The database schema 400 may include additional tables to track additional types of data, such as users, businesses, products, and the like. The invoice table 410 and the sales order table 440 may be combined into a single table that stores data for multiple types of documents.

Data from the invoice table 410 and the sales order table 440 may be selected using filters. For example, all invoices due in the next month may be selected by applying a filter to the Due Date column (e.g., SELECT*FROM Invoice_Table WHERE Due_Date>=“2024-05-01” AND Due_Date<=“2024-05-31”). As another example, all open sales orders may be selected by applying a filter to the Sales Order Status column (e.g., SELECT*FROM Sales_Order_Table WHERE Sales_Order_Status!=“CLOSED”). The filters may be specified using structured query language (SQL), as in the preceding examples, or using data structures. For example, the sales order filter may be implemented using the JSON below.

```
{
  “columns”: [ “Sales_Order_Number”, “Sales_Order_Status”, “Changed_On” ],
  “filters”: [{“column”: “Sales_Order_Status”, “operator”: “NE”, “value”: “closed” }]
}
```

In the example above, the “columns” value defines the columns of data to be returned from the query, the “filtersWhat” value defines the column to which filters will be applied, the “filtersOperator” value defines the operator to be used for the filter that will be applied to the filtered column (in this case, “not equal”), and the “filters Value” value defines the value to be used with the operator. Thus, the above example selects the Sales Order Number, Sales Order Status, and Changed On columns where the Sales_Order_Status is not equal to “CLOSED.”

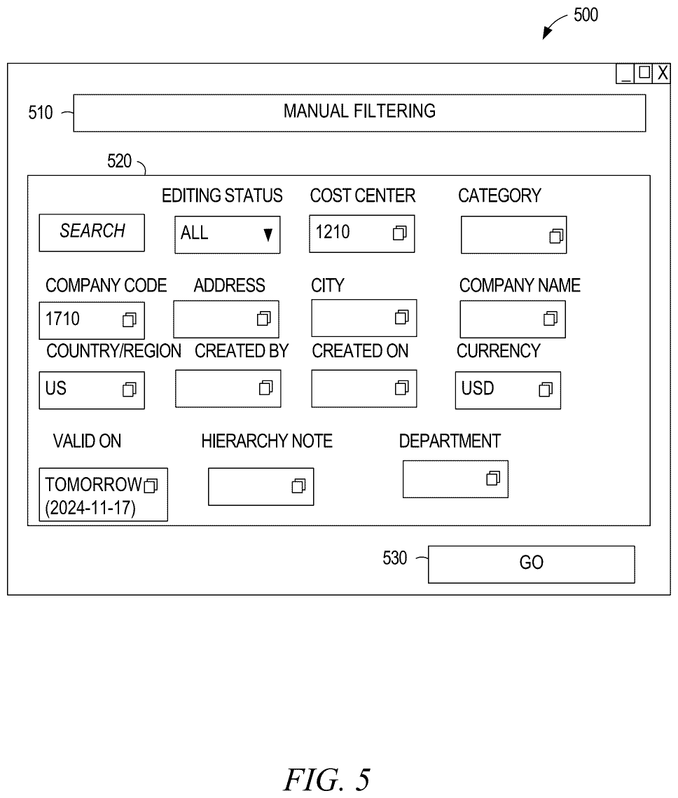

FIG. 5 shows an illustration of an example user interface 500 for manual data filtering. The user interface 500 may be generated by the application server 130A and presented on a display device of the client device 160A or 160B, all of FIG. 1. The user interface 500 may be presented to allow a user to manually select filters to be applied to a database table. The user interface 500 includes a title 510, a filter area 520, and a button 530.

The title 510 indicates that the user interface 500 includes options for manual filtering. The filter area 520 shows a search field options to configure filters for ten columns in a database. The user may individually configure filters for each column. Using the example shown in FIG. 5, the user may select records for cost center 1210, company code 1710, country US, currency USD, valid tomorrow (2024 Nov. 17) with any editing status. The selected filters are submitted to the application server 130A for processing in response to operation of the button 530.

By way of example and not limitation, the filter area 520 is shown as allowing the user to provide desired values to use for filtering. For example, results with company code equal to 1710 will be displayed. In other example embodiments, the filter area 520 may include selectors for the operator to be used for filtering. For example, the user may select equal, not equal, greater than, less than, greater than or equal, less than or equal, or any suitable combination thereof for numeric fields.

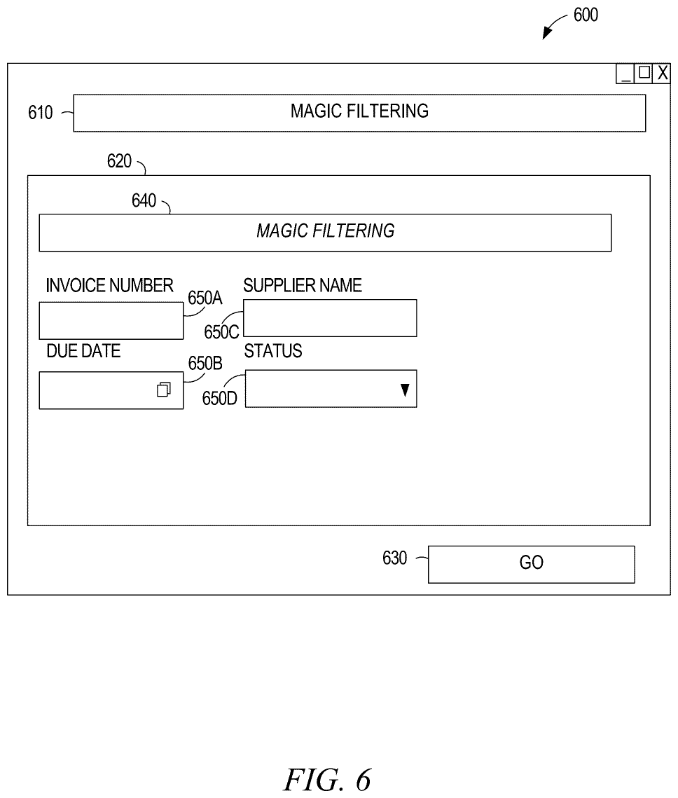

FIG. 6 shows an illustration of an example user interface 600 for LLM-powered data filtering. The user interface 600 may be generated by the application server 130A and presented on a display device of the client device 160A or 160B, all of FIG. 1. The user interface 600 may be presented to allow a user to provide natural-language instructions to generate filters to be applied to a database table. The user interface 600 includes a title 610, a filter area 620, and a button 630. The filter area 620 includes a text field 640 and additional options 650A, 650B, 650C, and 650D to configure filters manually.

Considering the user interface 500 of FIG. 5, if the table contains a lot of complex data (many rows and many columns), it can be difficult to get the desired view of the data (many filters to set). The user has to set every filter individually, and thus has to find the respective filter and find or fill in the desired values. The user needs to know the data and its meaning to set the filters correctly. By contrast, the user interface 600 is easier for both experienced and new users to use to set filters.

The text field 640 may receive text from a user for processing by an LLM. For example, the user may enter “filter the list by showing only new items, for customer XYZ, changed on today.” In some example embodiments, the user interacts with the user interface 600 by voice that is processed by a speech-to-text engine to generate text to populate the text field 640. The instructions may be submitted by operation of the button 630. The application server 130A provides instructions to the LLM server 140 based on metadata for the database being filtered. The application server 130A also provides the text received from the user to the LLM server 140. In response, the LLM server 140 provides output from an LLM including database commands.

The text provided by the user may identify tables, filters, columns, sort criteria, statistical data requests, modification instructions, or any suitable combination thereof. For example: “Show me all the invoices that are paid. I want to see the ‘created by’ column. Hide the column ‘responsive person.’” The modification instructions may include adding rows, deleting rows, modifying rows, or any suitable combination thereof. The statistical data requests may include requests for a sum, an average, a count, or any suitable combination thereof.

The database commands received from the LLM server 140 may be modified by the application server 130A in accordance with values set by the user using manual filters. For example, if the user provides a value in the Supplier Name text box, an additional filter may be added so that only results with the identified Supplier Name are provided. Thus, the user interface 600 includes both the text field 640 to receive the natural-language filtering instructions and multiple selectors 650A-650D, each operable to select one of a plurality of values. For example, the value for the due date field may be selected using a date-picker which provides a plurality of dates to pick from, the value for the status field may be selected from a drop-down list comprising a plurality of predetermined statuses, or any suitable combination thereof.

In some example embodiments, the selectors 650A-650D are not shown, so the user only provides natural-language instructions via the text field 640. This may be considered to be an “easy” mode, while a mode (such as that shown in FIG. 5) that allows users to directly enter filters may be considered an “advanced” mode. The user interfaces 500 and 600 may include an option to switch between easy and advanced modes. Thus, a user may provide a prompt in easy mode, which is converted by the LLM to explicit filters. Switching to advanced mode, the values of the explicit filters may be shown in the selectors 650A-650D or in the filter area 520 of FIG. 5. In advanced mode, the user may add, change, or delete the filters before submitting the query (or before resubmitting the query, in the event that the results from the LLM-generated query were unsatisfactory).

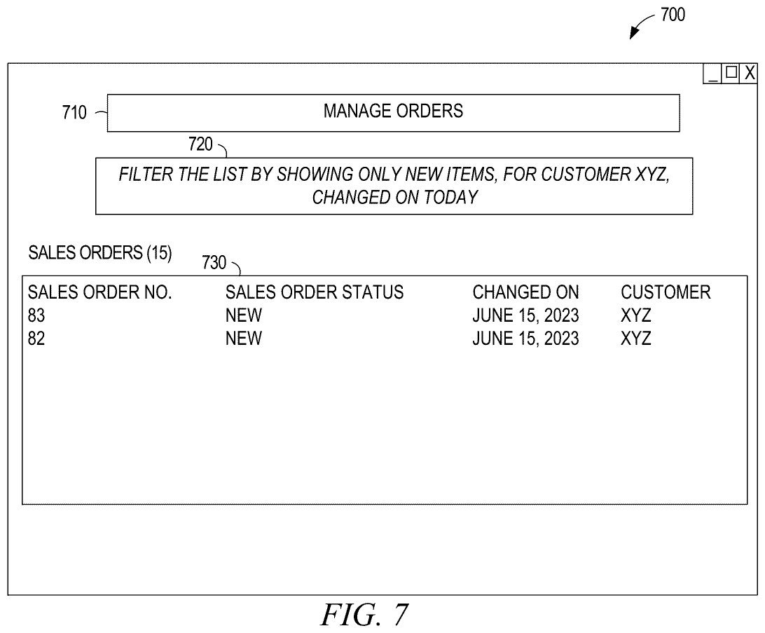

FIG. 7 shows an illustration of an example user interface 700 for displaying results from LLM-powered data filtering. The user interface 700 may be generated by the application server 130A and presented on a display device of the client device 160A or 160B, all of FIG. 1. The user interface 700 may be presented to show results for a query received from a user via the user interface 600 of FIG. 6. The user interface 700 includes a title 710, a prompt 720, and a results area 730.

The prompt 720 shows the text entered by a user into the text field 640 of FIG. 6. The text was provided to an LLM that generated database commands in response. The database commands were used to filter data from a database and at least a portion of the resulting, filtered, data is presented in the results area 730. As can be seen in FIG. 7, the prompt 720 specified “new items, for customer XYZ, changed on today.” Based on the information in the prompt, the LLM of the LLM server 140 of FIG. 1 generated database commands to filter on Sales Order Status=New, Changed On=Jun. 15, 2023, and Customer=XYZ. As a result, only records that met all three of the natural-language request criteria were provided in response to the request. The user interface 700 may include a filter area such as the filter area 520 of FIG. 5 to display the filters generated by the LLM and allow the user to easily modify the filters using a traditional selection interface.

In some example embodiments, the application server 130A maintains a session with the LLM server 140, allowing subsequent prompts to be provided to the same LLM. This allows the user to specify filter settings in subsequent prompts (e.g., using a chat format). For example, the user may modify or add to the text in the prompt 720, allowing the user to specify the prompt based on subsequent results and further correct or better specify the expected result.

The prompt 720 may include instructions for grouping or sorting results. For example, if each sales order is associated with a sales manager and multiple sales managers work with customer XYZ, the results in the results area 730 could be grouped by sales manager. As a another example, the sales orders could be sorted by sales order number.

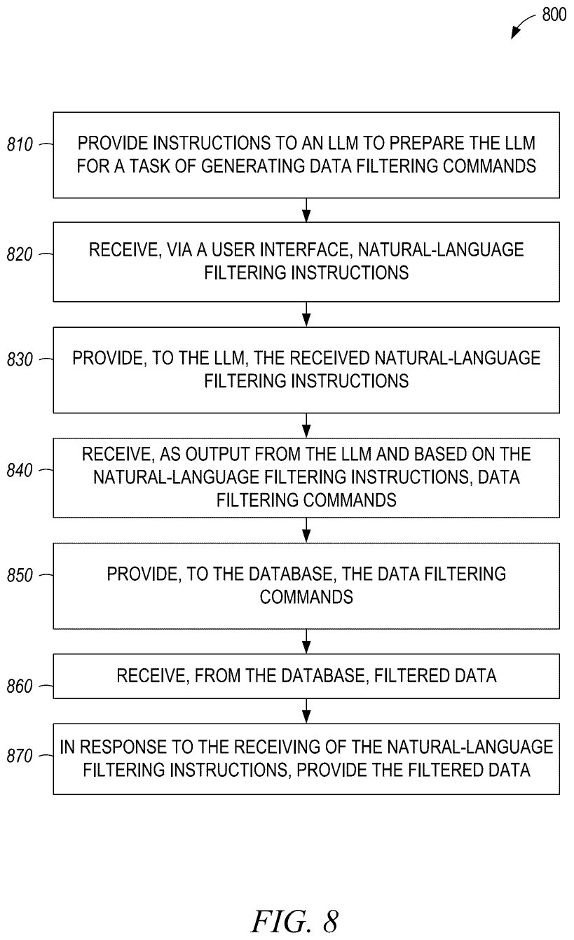

FIG. 8 shows a flowchart illustrating a method 800 of LLM-powered data filtering. The method 800 includes operations 810, 820, 830, 840, 850, 860, and 870. By way of example and not limitation, the method 800 is described as being performed by the application server 130A of FIG. 1, using the modules of FIG. 2 and the database schema of FIG. 4.

The application server 130A may determine a format suitable for providing filtering commands to a database. For example, metadata that describes the structure of one or more tables may be accessed and, based on the metadata, a JSON format may be determined that includes the names of columns of at least one of the one or more tables.

The application server 130A, in operation 810, provides instructions to an LLM to prepare the LLM for a task of generating data filtering commands. For example, the application server 130A may send the instructions to the LLM server 140 via the network 190. Example instructions may include:
You are creating filters for a table. The table has these columns (each written in the format name:data type):
{columns}
The table can show and hide columns (show all relevant and if you are not sure show all columns), the table can be sorted by column and each column can have its own filter based on its type.
Dates are in the format YYYY-MM-DD.
When you are asked to specify a range of dates or a specific date, always use filters on both sides. Use only these for operators: Contains (contains), Ends With (ends with), EQ (equals), GE (greater or equals), GT (greater than), LE (less or equals), LT (less than), NE (not equals), NotContains (not contains), NotEndsWith (not ends with), NotStartsWith (not starts with), StartsWith (starts with).
When you are asked to deal with dates, the current date and time is: {date}.
Generate the filter based on this prompt:

In the example above, {columns} is replaced with column names gathered from metadata. Thus, in some example embodiments, the providing of the instructions to the LLM comprises providing names of columns of a database table. In the example above, {date} is replaced with the current date and time. Accordingly, the providing of the instructions to the LLM may include providing the current date and time to the LLM.

The instructions to the LLM may include a template that instructs the LLM how to format a response. For example, the template below may be used:

```
{
  “tools”: [
  {
    “type”: “function”,
    “function”: {
    “name”: “table_filters”,
    “description”: “Give me filters for the table.”,
    “parameters”: {
      “type”: “object”,
      “properties”: {
      “columns”: {
        “type”: “array”,
        “description”: “Columns of the table to be visible.”,
        “items”: {
        “type”: “string”
        }
      },
      “filters”: {
        “type”: “array”,
        “description”: “Array of filters.”,
        “items”: {
        “properities”: {
          “type”: “object”,
          “description”: “Definition of a single filter.”,
          “properities”: {
          “column”: {
            “type”: “string”,
            “description”: “Which column to filter.”
          },
          “operator”: {
            “type”: “string”,
            “enum”: [
            “Contains”,
            “EndsWith”,
            “EQ”,
            “GE”,
            “GT”,
            “LE”,
            “LT”,
            “NE”,
            “NotContains”,
            “NotEndsWith”,
            “NotStartsWith”,
            “StartsWith”
            ],
            “description”: “Which operand to use.”
          },
          “value”: {
            “type”: “string”,
            “description”: “Value for filter.”
          }
          }
        },
        “required”: [
          “column”,
          “operator”,
          “value”
        ]
        }
      },
      “orderBy”: {
        “type”: “string”,
        “description”: “A column by which the table should be sorted.”
      },
      “orderDesc”: {
        “type”: “boolean”,
        “description”: “Select whether the order should be descending or not. If not, it is
ascending.”
      },
      “filterDescription”: {
        “type”: “string”,
        “description”: “Natural language description of all filters and sorting that must describe
the set filters. This description must be as short as possible.”
      }
      }
    }
    }
  }
  ],
  “tool_choice”: {
  “type”: “function”,
  “function”: {
    “name”: “table_filters”
  }
  }
}
        An alternative template is:
{
  “$schema”: “http://json-schema.org/draft-07/schema#”,
  “title”: “Filter table format.”,
  “type”: “object”,
  “properties”: {
  “columns”: {
    “type”: “array”,
    “description”: “Columns of the table to be visible.”,
    “items”: {
    “type”: “string”
    }
  },
  “filters”: {
    “type”: “array”,
    “description”: “Array of filters.”,
    “items”: {
    “type”: “object”,
    “description”: “Definition of a single filter.”,
    “properties”: {
      “column”: {
      “type”: “string”,
      “description”: “Which column to filter.”
      },
      “operator”: {
      “type”: “string”,
      “enum”: [
        “Contains”,
        “EndsWith”,
        “EQ”,
        “GE”,
        “GT”,
        “LE”,
        “LT”,
        “NE”,
        “NotContains”,
        “NotEndsWith”,
        “NotStartsWith”,
        “StartsWith”
      ],
      “description”: “Which operand to use.”
      },
      “value”: {
      “type”: “string”,
      “description”: “Value for filter.”
      }
    },
    “required”: [
      “column”,
      “operator”,
      “value”
    ]
    }
  },
  “orderBy”: {
    “type”: “string”,
    “description”: “A column by which the table should be sorted.”
  },
  “orderDesc”: {
    “type”: “boolean”,
    “description”: “Select whether the order should be descending or not. If not, it is ascending.”
  },
  “filterDescription”: {
    “type”: “string”,
    “description”: “Natural language description of all filters and sorting that must describe the
set filters. This description must be as short as possible.”
  }
  },
  “required”: [
  “filterDescription”
  ]
}
```

The “type” values in the templates above may be generated based on metadata for the database or metadata for the database table. For example, metadata for a database table may include the names of the columns of the table and the type of data (e.g., integer, string, boolean, array, and the like) of the data in each column. The format of filter conditions may vary depending on the type of data. For example, string values may be quoted while integer values are not. Thus, in some example embodiments, the method 800 includes determining the names of the columns of a database table based on metadata for the database, determining a format of filter conditions based on metadata for the database, or both.

In operation 820, the application server 130A receives, via a user interface, natural-language filtering instructions. For example, the natural-language filtering instructions may be provided by a user of the client device 160A into the text field 640 of FIG. 6. The web interface 170 sends the contents of the text field 640 to the application server 130A via the network 190.

The application server 130A provides, in operation 830, the received natural-language filtering instructions to the LLM. For example, the LLM server 140 may provide an application programming interface (API) for the submission of prompts and the application server 130A may use the API to provide the natural-language filtering instructions to an LLM of the LLM server 140.

The output from the LLM is generated based on the natural-language filtering instructions and is received by the application server 130A (operation 840). The output from the LLM comprises filtering commands according to the instructions provided in operation 810. For example, the JSON below may be received, comprising multiple filters:

```
{
  “columns”: [ “name”, “order_date”, “ordered_by”, “status” ],
  “filters”: [
    {“column”: “status”, “operator”: “NE”, “value”: “open”},
    {“column”: “order_date”, “operator”: “GT”, “value” “2024-01-11”}
      ],
  “orderBy”: “name”,
  “orderDesc”: false,
  “filterDescription”: “Showing all columns where status is not open and sorted by name.
Only showing invoices from the future.”,
}
```

In the above example, four columns are requested, two of which are filtered on. The two filters are “status;NE;open,” or status not equal to “open,” and “order_date;GT;2024-01-11,” or order date after Jan. 11, 2024. The filterDescription includes a natural-language description of the filters, as generated by the LLM.

The LLM may automatically add filters for columns not specified by the user. For example, if only one column contains names and the natural-language request mentions “John,” the LLM may generate filtering commands for the value of the column to be equal to “John,” even though the user did not specify the column to be filtered.

The LLM may generate filters differently based on the type of data being filtered. For example, the natural-language filtering instructions may be to retrieve invoices with “invoiceNumber equal to 111.” If the type of the invoiceNumber field is a string, the LLM may generate a filtering command to find records where:
invoiceNumber=“111”

However, if the type of the invoiceNumber field is a number (e.g., integer, floating-point, or the like), the LLM may generate a filtering command to find records where:
invoiceNumber=111

As another example, if the type is an enumeration, with a specific list of valid values, the LLM will use one of the valid values for the filter, even if the user uses a synonym. For example, if a status field can have values of only “open” or “closed” and a user requests “status that is not finished,” the LLM provides a filter of
status=“open”

In operation 850, the application server 130A provides the data filtering commands to the database server 150A. The output from the LLM may be processed before being provided to the database server 150A. For example, the output from the LLM may be in the form of the JSON object above while the database server 150A expects input in the form of SQL. Accordingly, the application server 130A may include a program that parses JSON and generates equivalent SQL.

In response, the application server 130A receives filtered data from the database (operation 860). Thus, the application server 130A is enabled to perform operation 870, providing the filtered data in response to the receiving of the natural-language filtering instructions (e.g., using the user interface 700 of FIG. 7).

Prior to providing the filtering commands to the database server 150A in operation 850, the application server 130A may modify the data filtering commands to include an additional filter based on a value selected using a selector in a user interface. For example, filters set using the invoice number, supplier name, due date, or status filters of the user interface 600 of FIG. 6 may be added to the data filtering commands provided by the LLM.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: providing instructions to a large language model (LLM) to prepare the LLM for a task of generating data filtering commands; receiving, via a user interface, natural-language filtering instructions; providing, to the LLM, the received natural-language filtering instructions; receiving, as output from the LLM and based on the provided natural-language filtering instructions, data filtering commands; providing, to a database, the data filtering commands; receiving, from the database, filtered data; and in response to the receiving of the natural-language filtering instructions, providing the filtered data.

In Example 2, the subject matter of Example 1, wherein the providing of the instructions to the LLM comprises providing names of columns of a database table.

In Example 3, the subject matter of Example 2, wherein the operations further comprise determining the names of the columns of the database table based on metadata for the database.

In Example 4, the subject matter of Examples 1-3, wherein the user interface includes a text field to receive the natural-language filtering instructions and a selector operable to select one of a plurality of values.

In Example 5, the subject matter of Example 4, wherein the operations further comprise modifying the data filtering commands to include an additional filter based on a value selected using the selector.

In Example 6, the subject matter of Examples 1-5, wherein the providing of the instructions to the LLM to prepare the LLM for the task of generating data filtering commands comprises providing a template for the data filtering commands.

In Example 7, the subject matter of Examples 1-6, wherein the providing of the instructions to the LLM to prepare the LLM for the task of generating data filtering commands comprises providing a current date.

In Example 8, the subject matter of Examples 1-7, wherein the providing of the instructions to the LLM to prepare the LLM for the task of generating data filtering commands comprises providing a list of valid operators.

In Example 9, the subject matter of Examples 1-8, wherein the operations further comprise: training the LLM by providing a training set comprising natural-language filtering instructions and JavaScript object notation (JSON) objects comprising corresponding filtering commands.

In Example 10, the subject matter of Examples 1-9, wherein the operations further comprise: training the LLM by providing a training set comprising natural-language filtering instructions and structured query language (SQL) strings comprising corresponding filtering commands.

Example 11 is a non-transitory computer-readable medium that stores instructions that, when executed by one or more processors, cause the one or more processors to perform operations comprising: providing instructions to a large language model (LLM) to prepare the LLM for a task of generating data filtering commands; receiving, via a user interface, natural-language filtering instructions; providing, to the LLM, the received natural-language filtering instructions; receiving, as output from the LLM and based on the provided natural-language filtering instructions, data filtering commands; providing, to a database, the data filtering commands; receiving, from the database, filtered data; and in response to the receiving of the natural-language filtering instructions, providing the filtered data.

In Example 12, the subject matter of Example 11, wherein the providing of the instructions to the LLM comprises providing names of columns of a database table.

In Example 13, the subject matter of Example 12, wherein the operations further comprise determining the names of the columns of the database table based on metadata for the database.

In Example 14, the subject matter of Examples 11-13, wherein the user interface includes a text field to receive the natural-language filtering instructions and a selector operable to select one of a plurality of values.

In Example 15, the subject matter of Example 14, wherein the operations further comprise modifying the data filtering commands to include an additional filter based on a value selected using the selector.

In Example 16, the subject matter of Examples 11-15, wherein the providing of the instructions to the LLM to prepare the LLM for the task of generating data filtering commands comprises providing a template for the data filtering commands.

In Example 17, the subject matter of Examples 11-16, wherein the providing of the instructions to the LLM to prepare the LLM for the task of generating data filtering commands comprises providing a current date.

Example 18 is a method comprising: providing, by one or more processors, instructions to a large language model (LLM) to generate data filtering commands; receiving, via a user interface, natural-language filtering instructions; providing, to the LLM, the received natural-language filtering instructions; receiving, as output from the LLM and based on the provided natural-language filtering instructions, data filtering commands; providing, to a database, the data filtering commands; receiving, from the database, filtered data; and in response to the receiving of the natural-language filtering instructions, providing the filtered data.

In Example 19, the subject matter of Example 18, wherein the providing of the instructions to the LLM comprises providing names of columns of a database table.

In Example 20, the subject matter of Example 19 includes determining the names of the columns of the database table based on metadata for the database.

Example 21 is an apparatus comprising means to implement of any of Examples 1-20.

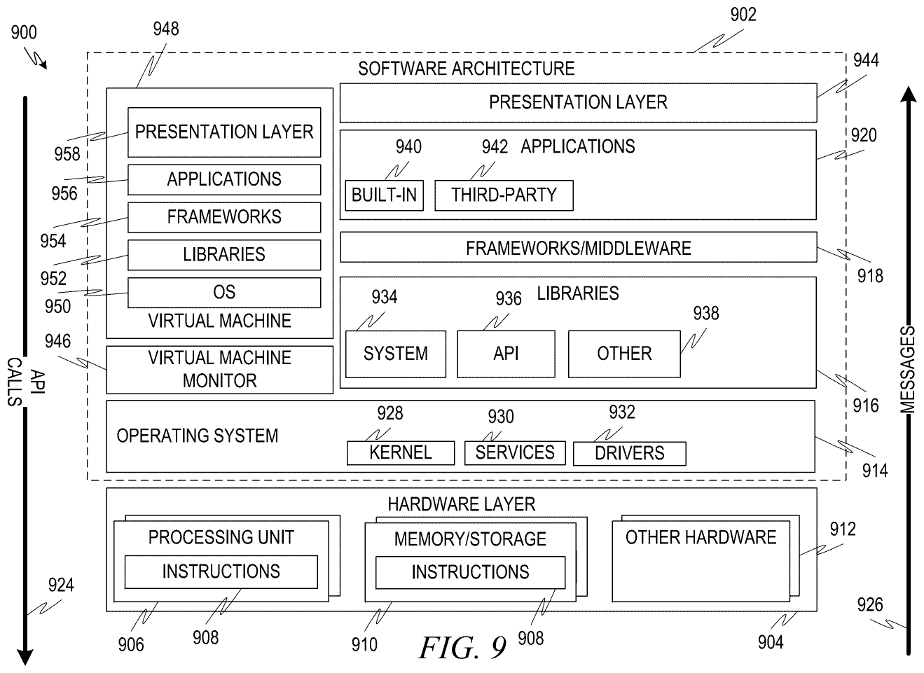

FIG. 9 shows a block diagram 900 showing one example of a software architecture 902 for a computing device. The software architecture 902 may be used in conjunction with various hardware architectures, for example, as described herein. FIG. 9 is merely a non-limiting example of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 may provide a higher-level common infrastructure that may be utilized by the applications 920 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), and frameworks/middleware 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 10 shows a block diagram of a machine in the example form of a computer system 1000 within which instructions 1024 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting a machine-readable medium 1022.

While the machine-readable medium 1022 is shown in FIG. 10 to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with the instructions 1024. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

1. A system comprising:
a memory that stores instructions; and
one or more processors coupled to the memory and configured to execute the instructions to perform operations comprising:
providing instructions to a large language model (LLM) to prepare the LLM for a task of generating data filtering commands;
receiving, via a user interface, natural-language filtering instructions;
providing, to the LLM, the received natural-language filtering instructions;
receiving, as output from the LLM and based on the provided natural-language filtering instructions, data filtering commands in a JavaScript Object Notation (JSON) object, the JSON object comprising an array of column names and an array of filters;
providing, to a database, the data filtering commands;
receiving, from the database, filtered data; and
in response to the receiving of the natural-language filtering instructions, providing the filtered data.

2. The system of claim 1, wherein the providing of the instructions to the LLM comprises providing names of columns of a database table.

3. The system of claim 2, wherein the operations further comprise determining the names of the columns of the database table based on metadata for the database.

4. The system of claim 1, wherein the user interface includes a text field to receive the natural-language filtering instructions and a selector operable to select one of a plurality of values.

5. The system of claim 4, wherein the operations further comprise modifying the data filtering commands to include an additional filter based on a value selected using the selector.

6. The system of claim 1, wherein the providing of the instructions to the LLM to prepare the LLM for the task of generating data filtering commands comprises providing a template for the data filtering commands.

7. The system of claim 1, wherein the providing of the instructions to the LLM to prepare the LLM for the task of generating data filtering commands comprises providing a current date.

8. The system of claim 1, wherein the providing of the instructions to the LLM to prepare the LLM for the task of generating data filtering commands comprises providing a list of valid operators.

9. The system of claim 1, wherein the operations further comprise:
training the LLM by providing a training set comprising natural-language filtering instructions and JavaScript object notation (JSON) objects comprising corresponding filtering commands.

10. The system of claim 1, wherein the operations further comprise:
training the LLM by providing a training set comprising natural-language filtering instructions and structured query language (SQL) strings comprising corresponding filtering commands.

11. A non-transitory computer-readable medium that stores instructions that, when executed by one or more processors, cause the one or more processors to perform operations comprising:
providing instructions to a large language model (LLM) to prepare the LLM for a task of generating data filtering commands;
receiving, via a user interface, natural-language filtering instructions;
providing, to the LLM, the received natural-language filtering instructions;
receiving, as output from the LLM and based on the provided natural-language filtering instructions, data filtering commands in a JavaScript Object Notation (JSON) object, the JSON object comprising an array of column names and an array of filters;
providing, to a database, the data filtering commands;
receiving, from the database, filtered data; and
in response to the receiving of the natural-language filtering instructions, providing the filtered data.

12. The non-transitory computer-readable medium of claim 11, wherein the providing of the instructions to the LLM comprises providing names of columns of a database table.

13. The non-transitory computer-readable medium of claim 12, wherein the operations further comprise determining the names of the columns of the database table based on metadata for the database.

14. The non-transitory computer-readable medium of claim 11, wherein the user interface includes a text field to receive the natural-language filtering instructions and a selector operable to select one of a plurality of values.

15. The non-transitory computer-readable medium of claim 14, wherein the operations further comprise modifying the data filtering commands to include an additional filter based on a value selected using the selector.

16. The non-transitory computer-readable medium of claim 11, wherein the providing of the instructions to the LLM to prepare the LLM for the task of generating data filtering commands comprises providing a template for the data filtering commands.

17. The non-transitory computer-readable medium of claim 11, wherein the providing of the instructions to the LLM to prepare the LLM for the task of generating data filtering commands comprises providing a current date.

18. A method comprising:
providing, by one or more processors, instructions to a large language model (LLM) to generate data filtering commands;
receiving, via a user interface, natural-language filtering instructions;
providing, to the LLM, the received natural-language filtering instructions;
receiving, as output from the LLM and based on the provided natural-language filtering instructions, data filtering commands in a JavaScript Object Notation (JSON) object, the JSON object comprising an array of column names and an array of filters;
providing, to a database, the data filtering commands;
receiving, from the database, filtered data; and
in response to the receiving of the natural-language filtering instructions, providing the filtered data.

19. The method of claim 18, wherein the providing of the instructions to the LLM comprises providing names of columns of a database table.

20. The method of claim 19, further comprising determining the names of the columns of the database table based on metadata for the database.
